(19) United States
(12) Patent Application Publication
(10) Pub. No.: US 2018/0004492 A1
(43) Pub. Date: Jan. 4, 2018

(54) SYSTEM AND METHOD TO AUTOMATICALLY GENERATE AND MODIFY A PROGRAM

(71) Applicant: Douglas YOUNG, Stamford, CT (US)

(72) Inventor: Douglas YOUNG, Stamford, CT (US)

(21) Appl. No.: 15/630,304

(22) Filed: Jun. 22, 2017

Related U.S. Application Data
(60) Provisional application No. 62/356,884, filed on Jun. 30, 2016.

(51) Int. Cl. G06F 9/44; G06F 9/445; G06F 11/36; G06F 17/30

(52) U.S. Cl. CPC G06F 8/36; G06F 11/3612; G06F 9/44521; G06F 17/30864

(57) ABSTRACT

There is provided a method and a system to modify a program automatically. The method includes: generating a program from a first subprogram and a second subprogram; executing the program to yield an interim result; comparing the interim result to a reference result; determining that the interim result is an improvement over the reference result; modifying the program; and repeating the executing, the comparing, and the determining, and the modifying to yield a result for the program that is an improvement over a target result.

### CROSS REFERENCE TO RELATED APPLICATIONS

This application claims priority from U.S. Provisional Application No. 62/356,884 filed on Jun. 30, 2016, the entire contents of which are incorporated herein by reference.

### BACKGROUND OF THE DISCLOSURE

### 1. Field of the Disclosure

The present disclosure relates to a system and a method to generate a program and then modify the program. More particularly, the present disclosure relates to a system and a method to generate and modify a data-driven program having a plurality of elements.

### 2. Description of the Related Art

When a programmer develops a program in any existing computer programming language, the programmer has to develop the program in a logical sequence and debug the program in accordance with the logical sequence. When there is an issue with a command code of the program, the entire program cannot be executed. Accordingly, it is very difficult to develop the program so that it can be executed independently from the logical sequence.

In the field of computer science, searching a predictive pattern from massive information is difficult because the predictive pattern is constantly changing with its environment. It is very difficult to have a fixed program find the predictive pattern in a dynamically changing environment because the fixed program fails to consider any update from the environment.

There is a need to have a system and a method that can generate and modify the program automatically.

### SUMMARY OF THE DISCLOSURE

There is provided a method comprising: generating a program from a first subprogram and a second subprogram; executing the program to yield an interim result; comparing the interim result with a reference result; determining that the interim result is an improvement over the reference result and a target result; replacing the reference result with the interim result; modifying the program; and repeating the executing, the comparing, the determining, the replacing, and the modifying to yield a result for the program that is an improvement over the target result.

Generating the program comprises: obtaining the first subprogram and the second program from a library; and linking the first subprogram with the second subprogram.

The program is in a form of machine code, and modifying the program is achieved by modifying the machine code.

The method further comprises generating a graphical representation of the program and transmitting the graphical representation to a display.

Modifying the program further comprises: receiving a communication to modify the graphical representation of the program, thus yielding a modification of the graphical representation; and modifying the program in accordance with the modification of the graphical representation.

The method further comprises: utilizing a first element corresponding to the first subprogram; and utilizing a second element corresponding to the second subprogram, wherein each of the first element and the second element comprises a first non-triggering connector for data input, and a second non-triggering connector for data output, wherein the second non-triggering connector of the first element is connected through a logical link with the first non-triggering connector of the second element to create the graphical representation on the display, and wherein the second subprogram is triggered by a triggering connector.

There is provided a system comprising: a processor; and a storage device that contains instructions that are readable by the processor to cause the processor to: generate a program from a first subprogram and a second subprogram; execute the program to yield an interim result; compare the interim result to a reference result; determine that the interim result is an improvement over the reference result and a target result; replace the reference result with the interim result; modify the program; and repeat the execute, the compare, the determine, the replace, and the modify to yield a result for the program that is an improvement over the target result.

To generate the program, the instructions cause the processor to: obtain the first subprogram and the second program from a library; and link the first subprogram with the second subprogram.

The program is in a form of machine code. The instructions cause the processor to: modify the machine code.

The system comprises further instructions that cause the processor to: generate a graphical representation of the program, and transmit the graphical representation to a display.

To modify the program, the instructions cause the processor to: receive a communication to modify the graphical representation of the program, thus yielding a modification of the graphical representation; and modify the program in accordance with the modification of the graphical representation.

The system comprises further instructions that cause the processor to: utilize a first element corresponding to the first subprogram; and utilize a second element corresponding to the second subprogram, wherein each of the first element and the second element comprises a first non-triggering connector for data input, and a second non-triggering connector for data output, wherein the second non-triggering connector of the first element is connected through a logical link with the first non-triggering connector of the second element to create the graphical representation on the display, and wherein the second subprogram is triggered by a triggering connector.

A storage device that is non-transitory and that contains instructions that are readable by a processor causes the processor to: generate a program from a first subprogram and a second subprogram; execute the program to yield an interim result; compare the interim result to a reference result; determine that the interim result is an improvement over the reference result and a target result; replace the reference result with the interim result; modify the program; and repeat the execute, the compare, the determine, the replace, and the modify to yield a result for the program that is an improvement over the target result.

To generate the program, the instructions cause the processor to: obtain the first subprogram and the second program from a library; and link the first subprogram with the second subprogram.

The program is in a form of machine code, and the instructions cause the processor to: modify the machine code.

The storage device comprises further instructions that cause the processor to: generate a graphical representation of the program, and transmit the graphical representation to a display.

To modify the program, the instructions cause the processor to: receive a communication to modify the graphical representation of the program, thus yielding a modification of the graphical representation; and modify the program in accordance with the modification of the graphical representation.

The storage device comprises further instructions that cause the processor to: utilize a first element corresponding to the first subprogram; and utilize a second element corresponding to the second subprogram, wherein each of the first element and the second element comprises a first non-triggering connector for data input, and a second non-triggering connector for data output, wherein the second non-triggering connector of the first element is connected through a logical link with the first non-triggering connector of the second element to create the graphical representation on the display, and wherein the second subprogram is triggered by a triggering connector.

The first element communicates with the second element through a global channel or a local channel.

The connector determines a triggering sequence for the second element.

The first element and the second element can be copied and pasted to avoid a cross link. The first element and the second element can be copied and pasted to divide a complex program into a plurality of subprograms.

The program comprises a start element and a dispose element.

Each connector of the first non-triggering connector, the second non-triggering connector and the triggering connector comprises an identification number to identify the connector, a date holder to hold a data value, and a state field that shows connector statistics. Each connector determines a triggering sequence, and receives and delivers data update.

Each element of the first element and the second element further comprises an identification number to identify the first element and the second element and a function.

### BRIEF DESCRIPTION OF THE DRAWINGS

The disclosure is explained hereinafter with reference to the drawing. The drawing shows:

FIG. 1 is a block diagram of a system that generates and modifies a program automatically.

FIG. 2 is a block diagram of a program module of the system of FIG. 1.

FIG. 3 is a flow chart of a method executed by the program module of FIG. 2.

FIG. 4 is an example of a program generated and modified by the program module of FIG. 2.

FIG. 5 is an example of the program generated by the program module of FIG. 2.

FIG. 6 is an example of the program being modified by the program module of FIG. 2.

FIG. 7 is an exemplary graphical representation of the program of FIG. 4.

FIG. 8 is an exemplary element of the program of FIG. 4.

FIG. 9 is an exemplary connector when a connector has more than one subscriber.

FIG. 10 is an exemplary connector of the program of FIG. 4.

FIG. 11 is an exemplary graphical representation of a program with links crossed.

FIG. 12 is an exemplary graphical representation of the program of FIG. 11 without links crossed.

FIG. 13 is an example of dividing the program of FIG. 12.

FIG. 14 describes a start element and a dispose element.

FIG. 15 is a diagram of a first page of a program to communicate with a second page of the program through a global channel.

FIG. 16 is an example of a grouped element and an example of communicating with an element inside the grouped element through a local channel.

FIG. 17 is an example of generating a program.

FIG. 18 is an exemplary application of the present disclosure in a stock market.

A component or a feature that is common to more than one drawing is indicated with the same reference number in each of the drawings.

### DESCRIPTION OF THE DISCLOSURE

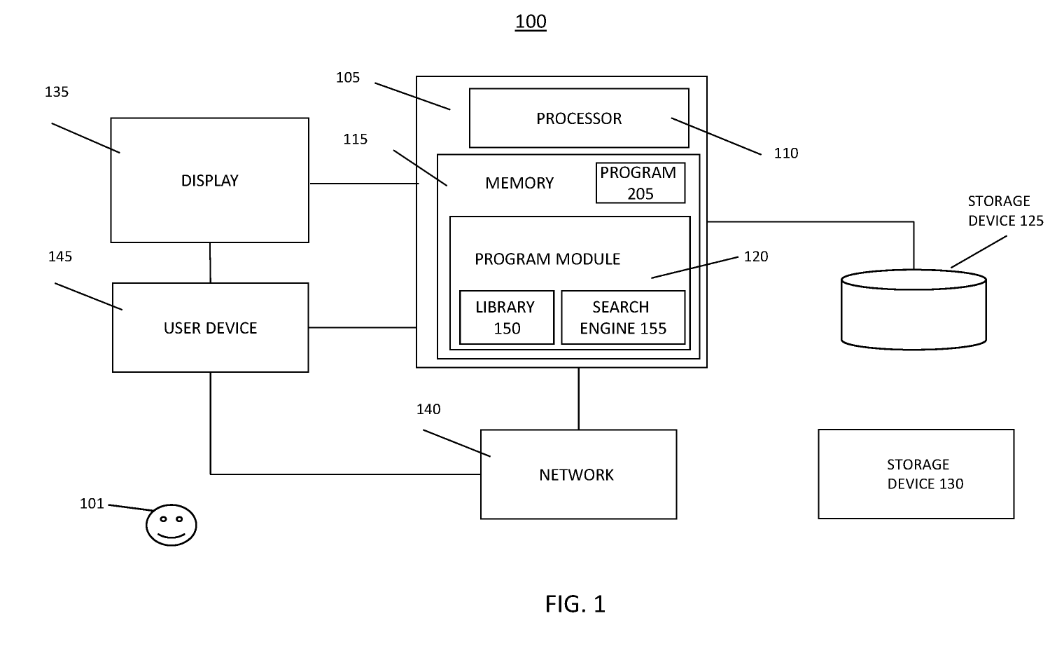

FIG. 1 is a block diagram of a system that generates and modifies a program automatically.

System 100 includes a computer 105 coupled to a network 140, a storage device 130, and a user device 145.

Network 140 is a data communications network. Network 140 may be a private network or a public network, and may include any or all of (a) a personal area network, e.g., covering a room, (b) a local area network, e.g., covering a building, (c) a campus area network, e.g., covering a campus, (d) a metropolitan area network, e.g., covering a city, (e) a wide area network, e.g., covering an area that links across metropolitan, regional, or national boundaries, (f) the Internet, or (g) a telephone network. Communications are conducted via network 140 by way of electronic signals and optical signals.

Computer 105 includes a processor 110 and a memory 115 coupled to processor 110. Although computer 105 is represented herein as a standalone device, it is not limited to such, but instead can be coupled to other devices (not shown) in a distributed processing system. For example, computer 105 is coupled to user device 145 and a display 135.

Processor 110 is an electronic device configured of logic circuitry that responds to and executes instructions.

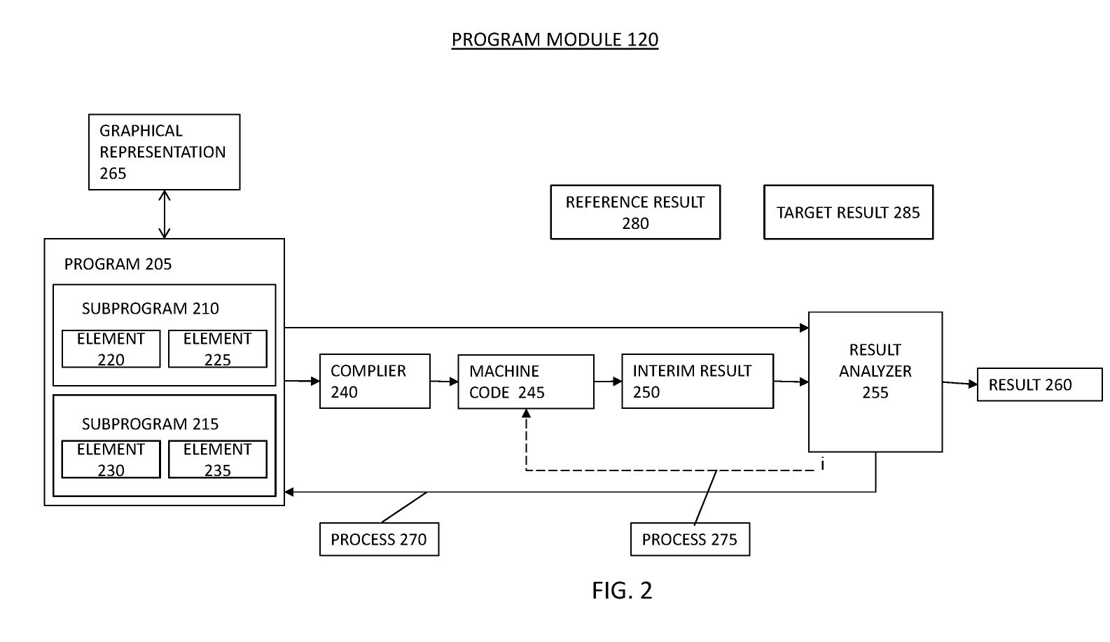

Memory 115 is a tangible computer-readable storage medium encoded with a computer program. In this regard, memory 115 stores files and instructions, for example, a program 205, that are readable and executable by processor 110 for controlling the operation of processor 110. Memory 115 can be implemented in a random access memory (RAM), a hard disc drive, solid-state drive, a read only memory (ROM) or a combination thereof. Memory 115 includes as a program module 120 and a program 205. Program 205 is described in FIG. 2.

Program module 120 includes a library 150 and a search engine 155, and contains instructions for controlling processor 110 to execute the method described herein. For example, under control of program module 120, processor 110 executes an automatic programming process.

The term “module” is used herein to denote a functional operation that may be embodied either as a stand-alone component or as an integrated configuration of a plurality of subordinate components. Thus, program module 120 may be implemented as a single module or as a plurality of modules that operate in cooperation with one another. Moreover, although program module 120 is described herein as being installed in memory 115, and therefore being implemented in software, it could be implemented in any of hardware (e.g., electronic circuitry), firmware, software, or a combination thereof.

While program module 120 is indicated as already loaded into memory 115, it may be configured on storage device 130 for subsequent loading into memory 115. Storage device 130 is a tangible computer-readable storage medium that stores program module 120 thereon. Examples of storage device 130 include a compact disk, a magnetic tape, a read only memory, an optical storage media, a hard drive or a memory unit consisting of multiple parallel hard drives, and a universal serial bus (USB) flash drive. Alternatively, storage device 130 can be a random access memory, or other type of electronic storage device coupled to computer 105 via network 140.

Library 150 stores a plurality of subprograms and programs that have been generated and will be generated by program module 120. A subprogram includes a plurality of elements. An element includes a function. A function of an element includes one or more program codes. A program code can be an assembly code. An assembly code is a low-level programming language for a computer or other programmable devices, and can correspond to machine code instructions. Usually there is a one-to-one correspondence between the assembly code and a machine code instruction. Accordingly, when program module 120 modifies program 205, program module can modify assembly code or modifies machine code.

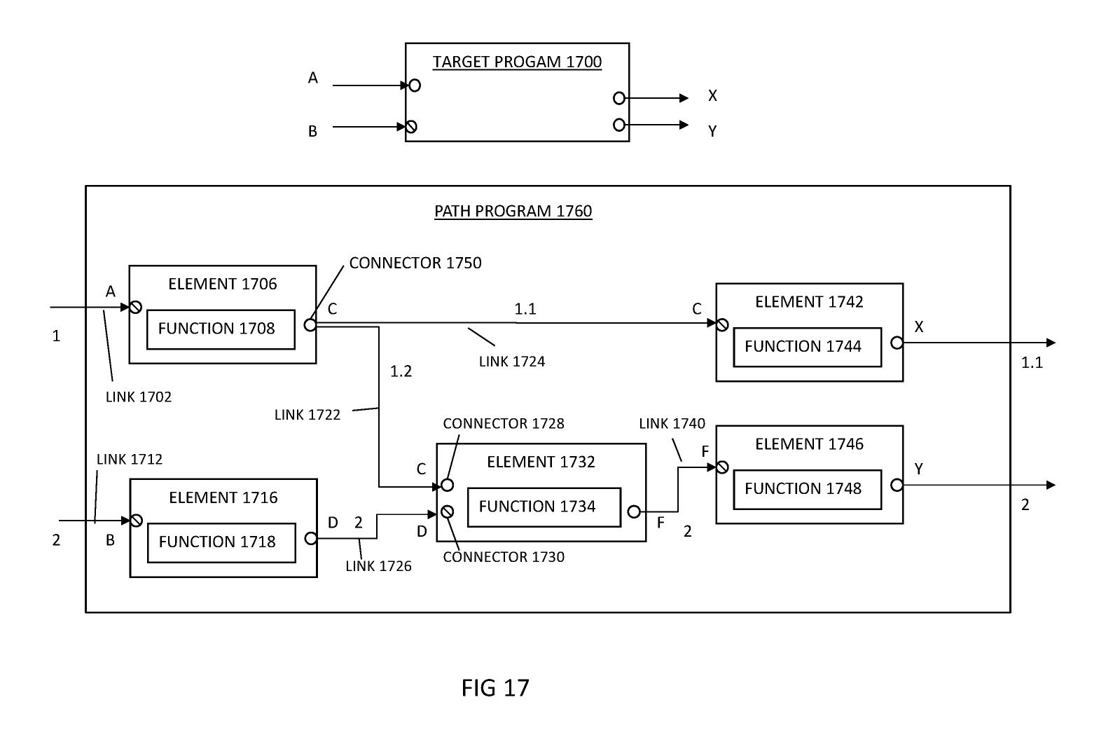

Search engine 155 is a local or network search engine. The detail description of search engine 155 is presented in FIG. 17.

Storage device 125 stores a plurality of programs and subprograms. Storage device 125 stores the plurality of programs and subprograms in accordance with the functions inside the plurality of programs and subprograms. It also stores information of usage record of the plurality of programs and subprograms.

Storage device 125 and storage device 130 may be implemented in any form of storage device. They may be implemented as separate components, e.g., two separate hard drives, or in a common physical component, e.g., a single database.

User device 145 includes an input device, such as a keyboard, speech recognition subsystem or gesture recognition subsystem, for enabling a user 101 to communicate information via network 140, to and from computer 105. User device 145 also includes an output device such as display 135 or a speech synthesizer. A cursor control or a touch-sensitive screen allows user 101 to utilize user device 145 for communicating additional information and command selections to processor 110 and computer 105.

Processor 110 outputs, to user device 145, a result of an execution of the method described herein.

In the present disclosure, although operations are described as being performed by computer 105, or by system 100 or its subordinate systems, the operations are actually performed by processor 110.

FIG. 2 is a block diagram of program module 120.

Program module 120 includes a complier 240, machine code 245, an interim result 250, a result analyzer 255, a result 260, a graphical representation 265 of program 205, a reference result 280, and a target result 285. Program module 120 generates program 205.

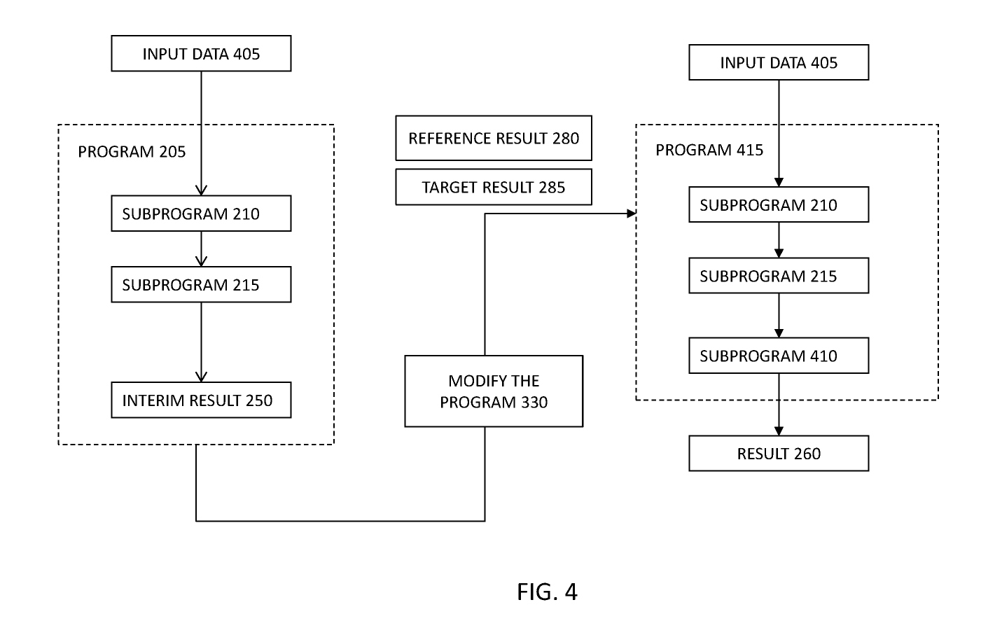

Program 205 includes a subprogram 210 and a subprogram 215. Subprogram 210 includes an element 220 and an element 225. Subprogram 215 includes an element 230 and an element 235. Program 205 is generated by linking subprogram 210 and subprogram 215 through logical links. Program module 120 can modify program 205. When program 205 is modified, a modified program 205 can comprise subprograms different from subprogram 210 and subprogram 215, and can have different linking paths, which is described in FIG. 4.

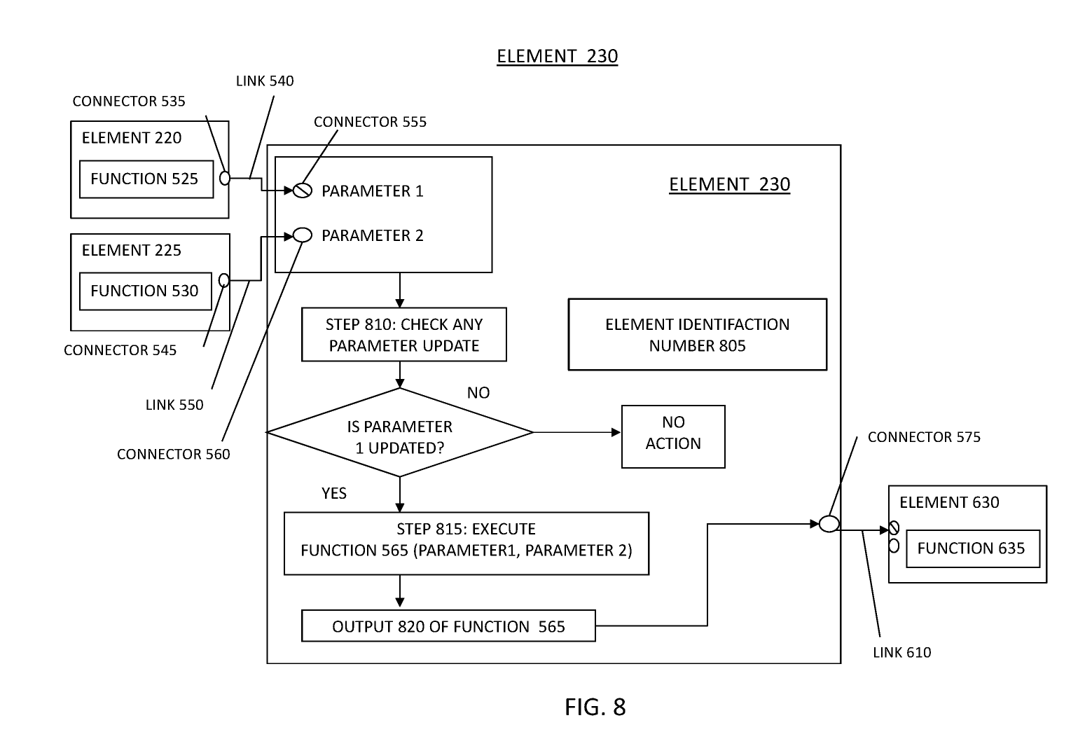

Subprogram 210 is generated by linking element 220 and element 225 with a logical link. Subprogram 215 is generated by linking element 230 and element 235 with a logical link. An example of an element is in FIG. 8.

After program 205 is generated, compiler 240 compiles program 205 to generate machine code 245. Program module 120 executes machine code 245, and yields interim result 250 of program 205.

Result analyzer 255 analyzes interim result 250 to determine whether interim result 250 is an improvement over reference result 280, and further determine whether interim result 250 is an improvement over target result 285. The improvement is evaluated by a machine time, accuracy of interim result 250, and code length, etc.

Reference result 280 can be updated from time to time as program 205 is modified. More specifically, when interim result 250 is an improvement over reference result 280, reference result 280 will be replaced with interim result 250. Target result 285 is an ideal result for program 205. Target result 285 can be the same as reference result 280, or is an improved result over reference result 280.

When result analyzer 255 determines that interim result 250 is an improvement over reference result 280, but interim result 250 is still not as good as target result 285, program module 120 modifies program 205 through a process 270. A method of modifying program 205 is describe in FIG. 4 and is further described in FIG. 17.

Program module 120 can modify machine code 245 to have interim result 250 through a process 275.

When process 270 modifies program 205, program 205 can have one or more additional subprograms, or remove one or more subprograms from program 205. Program 205 can be completely modified and does not have subprogram 210 and subprogram 215 at all.

When result analyzer 255 determines that interim result 250 is an improvement over reference result 280 and meets target result 285, program module 120 yields result 260.

When result analyzer 255 determines that interim result 250 is not an improvement over reference result 280, program 205 can be abandoned. Program module 120 generates a new program 205. New program 205 can include one of subprogram 210 and subprogram 215. New program 205 can be a different program without subprogram 210 and subprogram 215 at all.

Subprogram 210 can include a single element such as element 220. Subprogram 215 can include a single element such as element 230.

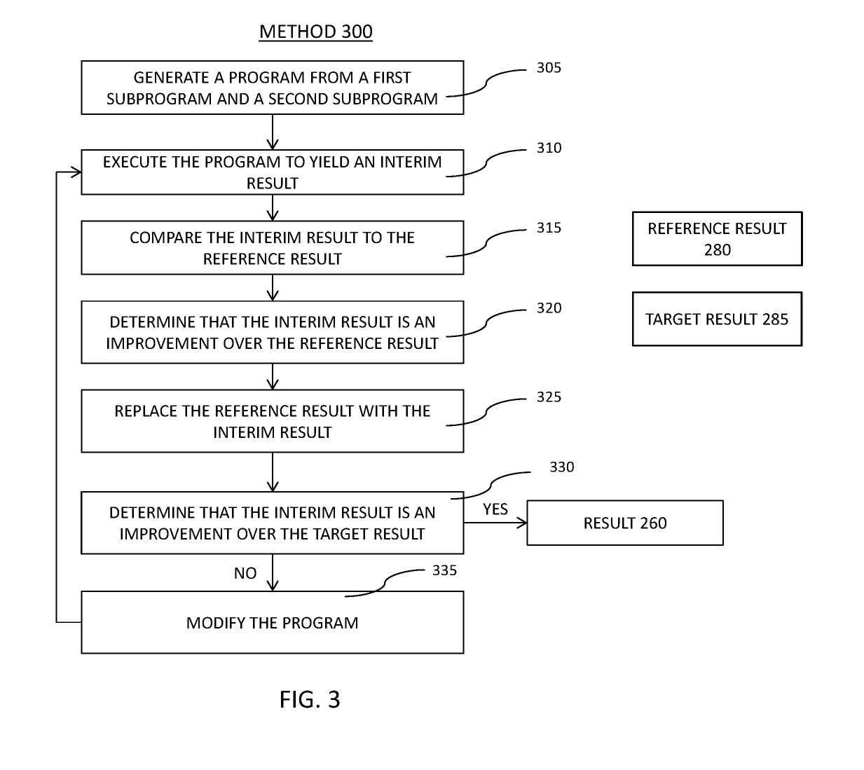

FIG. 3 is a flow chart of a method 300 executed by program module 120 of FIG. 2. Method 300 includes a step 305 through a step 335. Step 305 to step 335 are described below.

During step 305, program module 120 generates program 205 from subprogram 210 and subprogram 215.

During step 310, compiler 240 compiles program 205, and program module 120 executes machine code 245 to yield interim result 250.

During step 315, result analyzer 255 compares interim result 205 to reference result 280.

During step 320, program module 120 determines that interim result 250 is an improvement over reference result 280.

During step 325, program model 120 replaces reference result 280 with interim result 250.

During step 330, program module 120 determines that interim result 250 is an improvement over target result 285. If interim result 250 is not an improvement over target result 285, program module 120 modifies program 205 during step 335. Program module 120 repeats step 310 to step 335 to have result 260 that is an improvement over target result 285. If interim result 250 is an improvement over target result 285, program module 120 yields result 260.

Again, an improvement over reference result 280 or target result 285 can be justified by machine time, program accuracy, or code length, etc.

FIG. 4 is an example of program 205 that is generated and modified by program module 120 of FIG. 2.

Program 205 has subprogram 210 and subprogram 215, and has an input data 405. Program module 120 yields interim result 250 for program 205. Result analyzer 255 determines that interim result 250 is not an improvement over reference result 280. Accordingly, there is no replacement for reference result 280 with interim result 250. Program module 120 modifies program 205 through step 335. Program 205 is modified to a program 415. Program 415 includes subprogram 210, subprogram 215 and subprogram 410. Program module 120 yields result 260 that is an improvement over target result 285.

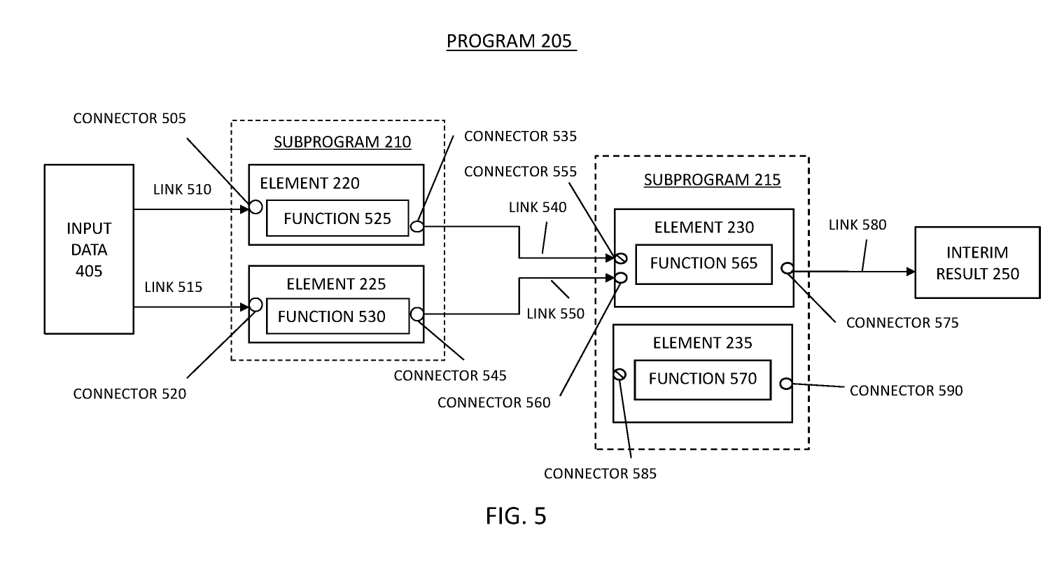

FIG. 5 is an example of program 205 generated by program module 120 of FIG. 2.

Program 205 includes subprogram 210 and subprogram 215.

Subprogram 210 includes element 220 and element 225.

Element 220 has a function 525, a non-triggering connector 505 for data input, and a non-triggering connector 535 for data output. Element 220 receives input data 405 through a link 510 and delivers output data to element 230 through a link 540.

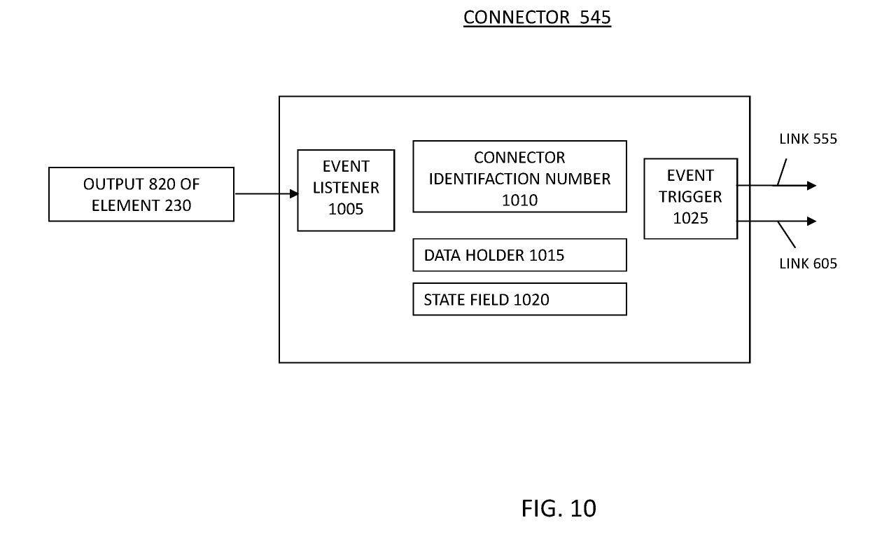

Element 225 includes a non-triggering connector 520, a function 530 and a non-triggering connector 545 for data output to element 230. Element 225 receives input data 405 through a link 515 and delivers output data to element 230 through a link 550. As an example, connector 545 is described in FIG. 10.

Subprogram 215 includes element 230 and element 235.

Element 230 has a triggering connector 555, a function 565, a non-triggering connector 560, and a non-triggering connector 575. Connector 555 triggers function 565. Element 230 receives output data of element 225 before connector 555 triggers function 565. Element 230 receives input data from element 225 through link 550 and generates interim result 250 through a link 580.

Element 235 has a triggering connector 585 for data input, a function 570 and a non-triggering connector 590 for date output. Element 235 does not have an active role in subprogram 215.

Links 510, 515, 540, 550 and 580 transmit data among connectors in program 205. For example, output data of element 220 is directed to element 230 logically through link 540. Each link of links 510, 515, 540, 550 and 580 has an identification number and stores a triggering sequence determined by connectors that are connected to links 510, 515, 540, 550 and 580. For example, link 540 stores a triggering sequence determined by connector 535.

Functions 525, 530, 565 and 570 each comprise a plurality of program codes. Functions 525 and 530 are self-executing and no triggering is necessary. Function 565 is triggered by output data of element 220 that has a triggering connector 555. When output data of element 220 has an update, function 565 will be triggered. When output data of element 220 does not have an update, function 565 will not be triggered. Function 570 has triggering connector 585, but function 570 is not triggered in program 205.

Program module 120 executes program 205 and yields interim result 250.

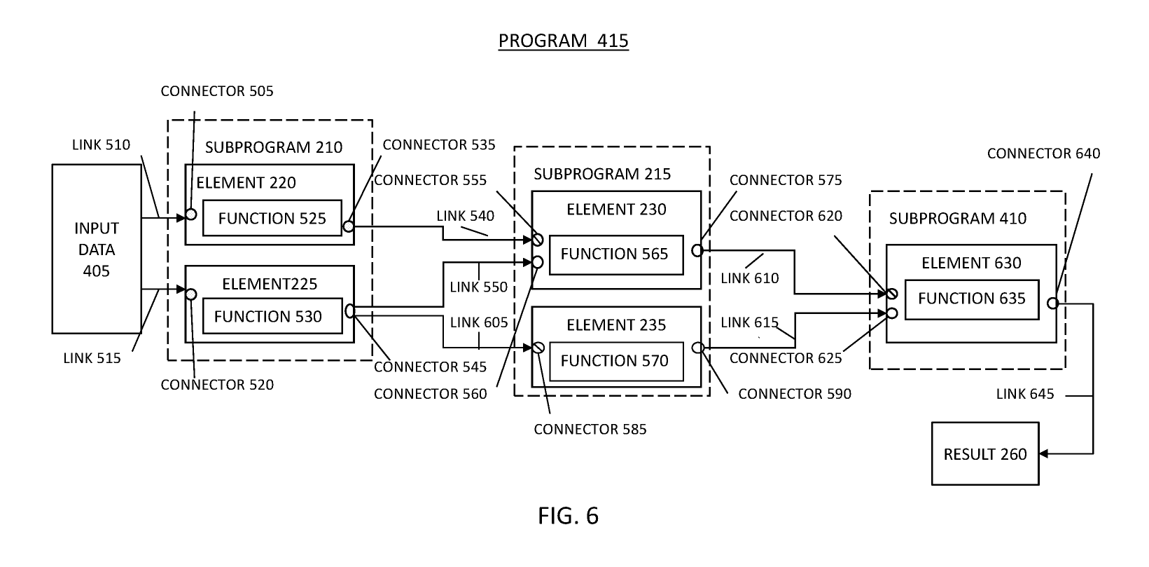

FIG. 6 is an example of a program 415 being modified by program module 120 of FIG. 2. More specifically, program 415 is a modified program of program 205 by program module 120.

Program 415 includes subprogram 210, subprogram 215 and a subprogram 410. Subprograms 210 and 215 are the same as these described in FIG. 5. No further description for subprograms 210 and 215 is included.

Different from program 205, element 235 of subprogram 235 has an active role in program 415. More specifically, element 235 receives output data of element 225 through triggering connector 585. When output data of element 225 is updated, function 570 will be triggered. When there is no update from output data of element 225, function 570 will not be triggered.

Subprogram 410 includes an element 630, a function 635, a triggering connector 620 to trigger function 635, a non-triggering connector 625 for data input from element 235, and a non-triggering connector 640 for data output.

Function 635 includes a plurality of program codes. Function 635 is triggered by output data of element 230.

Program module 120 executes program 415 and yields result 260.

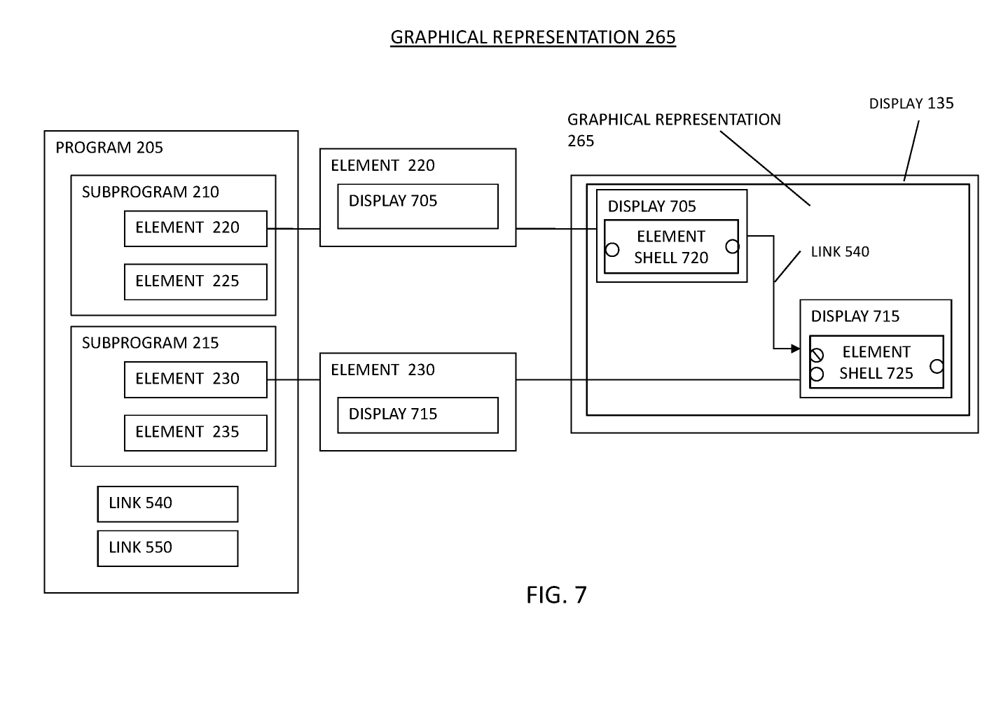

FIG. 7 is an example of graphical representation 265 of program 205 of FIG. 4.

Program 205 includes subprogram 210 and subprogram 215. Subprogram 210 includes element 220 and element 225. Element 220 includes a display 705. Display 705 includes an element shell 720. Element shell 720 includes a rectangular box, connectors of element 220 (i.e., connectors 505 and 535) and element identification number.

Element 230 includes a display 715. Display 715 includes an element shell 725. Element shell 725 includes a rectangular box, connectors of element 230 (i.e., connectors 555, 560, and 575) and an element identification number 805 (shown in FIG. 8).

Element shell 720 and element shell 725 are connected logically by link 540. As a part of graphical representation 265, display 705 and display 715 and link 540 are displayed on display 135. In graphical representation 265, link 265 visually shows that output date of element 220 is directed to element 230.

FIG. 8 is an example of element 230 of program 205.

Element 230 includes function 565, element identification number 805, triggering connector 555, non-triggering connector 560 and non-triggering connector 575. Function 565 has two variables parameter 1 and parameter 2.

After element 230 receives parameter 1 from element 220 and parameter 2 from element 225, element 230 will perform a legitimate check. More specifically, after connector 555 receives parameter 1, a state field 1020 of connector 555 (shown in FIG. 10) will check whether parameter 1 is legitimate or not. For example, if function 565 requires parameter 1 to be a string, but input data of parameter 1 from element 220 is a number. State field 1020 will determine that input data of parameter 1 from element 220 cannot be applied to function 565. As function 565 is unable to handle parameter 1 and parameter 2, function 565 will not be executed, and element 230 will not have any output data. Accordingly, element 230 will take no action.

However, if state field 1020 determines that input date to connector 555 is legitimate, element 230 will perform step 810 to check whether there is any update for parameter 1 and parameter 2. If there is no update, element 230 will take no action.

Parameter 1 is a triggering parameter. When parameter 1 is updated, parameter 1 will trigger function 565. When parameter 1 is not updated, function 565 will not be triggered.

Parameter 2 is a non-triggering parameter. After a legitimate check, if there is an update for parameter, a new parameter 2 will replace the previous parameter 2 in element 230.

Element 230 receives parameter 2 before element 230 receives parameter 1 in accordance with triggering sequences determined by connectors 535 and 545. If parameter 2 does not have any update, function 565 is still triggered with parameter 1, but element 230 will not have an updated output 820, because parameter 2 is not updated.

After function 565 is executed, output 820 will be directed to element 630 logically via link 610.

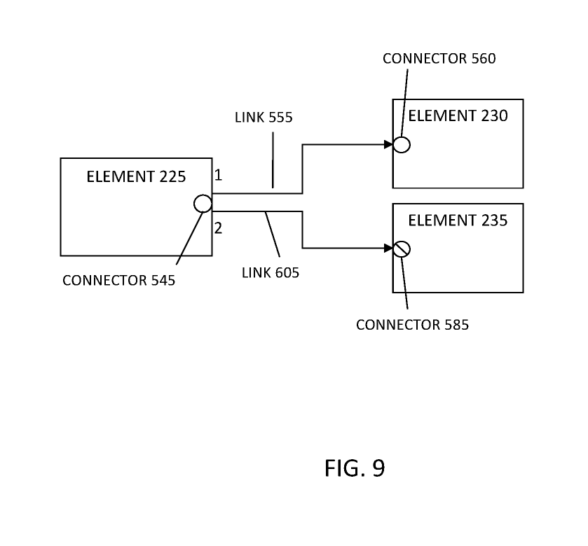

FIG. 9 is an exemplary connector when a connector has more than one subscriber.

Element 225 has a connector 545. Connector 545 is connected with element 230 and element 235 through link 555 and link 605, respectively. Output data of element 225 is subscribed by both element 230 and element 235. There are sequence numbers for elements 230 and 235 to receive output data of element 225. Connector 545 determines the sequence numbers, and assigns a sequence number to each of link 555 and link 605 in accordance with the sequence numbers. Program module 120 or user 101 can modify the sequence numbers. During execution of element 225, output data of element 225 can be directed to element 230 and element 235 in accordance with the sequence numbers.

FIG. 10 is an exemplary connector 545 of program 205 of FIG. 4.

Connector 545 includes an event listener 1005, an event trigger 1025, a connector identification number 1010, a date holder 1015 and state field 1020.

Event listener 1005 can subscribe output 820 of element 225. When event Listener 1005 receives a data update, it stores the data update to data holder 1015, and delivers to event trigger 1025 for a subscriber that subscribes the data update of element 230.

Connector identification number 1010 is a unique number for connector 545. Connector identification number 1010 is generated when program 205 is generated. Connector identification number 1010 is critical for finding the connector. Connector identification number 1010 helps to draw logical inks between connectors, and set up data subscription of connector 545.

Event trigger 1025 determines a sequence number and transfers the sequence number to a link that is logically connected with event trigger 1025. Determination of the sequence number is described in FIG. 9. Event trigger 1025 can have more than one element that subscribes data update of connector 545.

Data holder 1015 stores data information associated with connector 545.

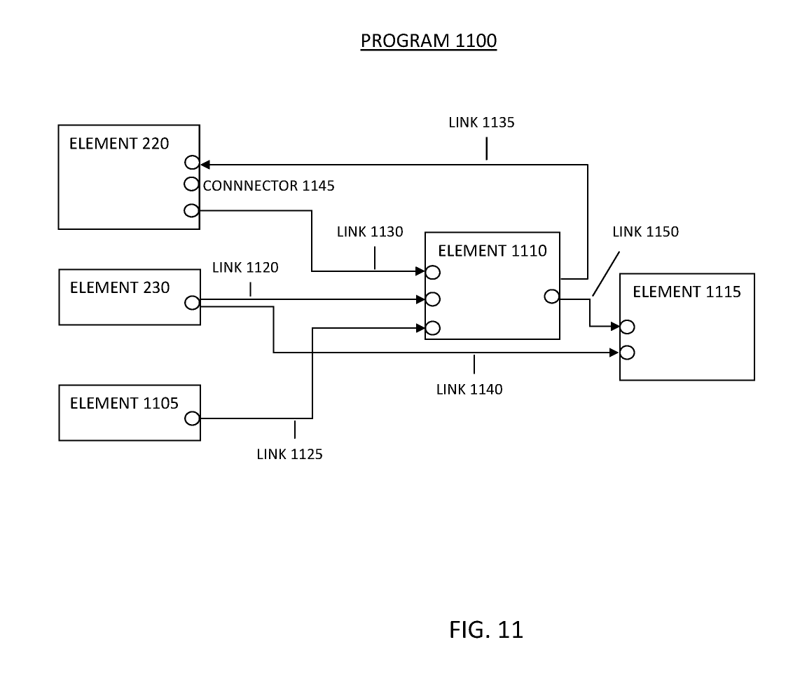

FIG. 11 is an exemplary graphical representation of a program with links crossed.

A program 1100 includes element 220, element 230, an element 1105, an element 1110 and an element 1115. Element 1110 receives output of element 210 via a link 1130 and sends output to element 220 via a link 1135. Accordingly, element 220, link 1130, element 1110 and link 1135 form a closed loop. When element 220 connects to an element outside of this loop, the connection will have a cross link. For example, element 220 has a connector 1145 inside the loop. When there is any link between connector 1145 and another element, a cross link appears. When there is a cross link, it is difficult to have a well-organized graphical representation of program 1110.

Further, element 1115 receives output of element 230 via a link 1140. Element 1110 receives output of element 1105 via a link 1125. Link 1125 and link 1140 are directly crossed.

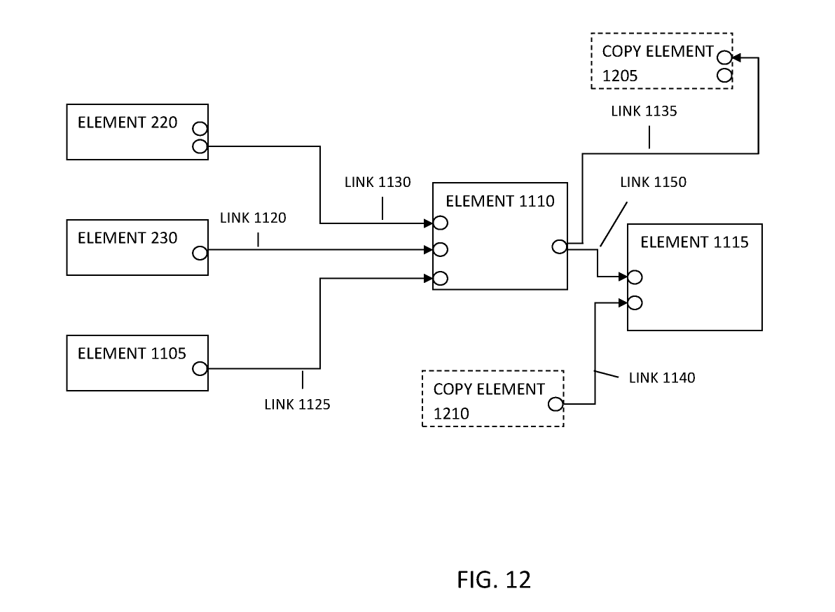

FIG. 12 is an exemplary graphical representation of the program of FIG. 11 without links crossed.

A solution to solve a cross link problem is to create a copy element. An element can be copied based on identification number of the element. For example, in FIG. 12, a copy element 1205 is generated by copying and pasting element 220 on display 135. Copy element 1205 and element 220 share a same identification number. Copy element 1205 has a same display 705 and same element shell 720 as element 220. Element shell 720 of copy element 1205 and element 220 both appear on display 135. During execution of program 1110, all links connected to copy element 1205 are actually connected to original element 220.

Similarly, a copy element 1210 is generated by copying and pasting element 230. Copy element 1210 and element 230 share a same identification number. Copy element 1210 has a same display 715 and a same element shell 725 as element 230. Element shell 725 of copy element 1205 and element 220 both appear on display 135. During execution of program 1110, all links connected to copy element 1210 are actually connected to original element 230.

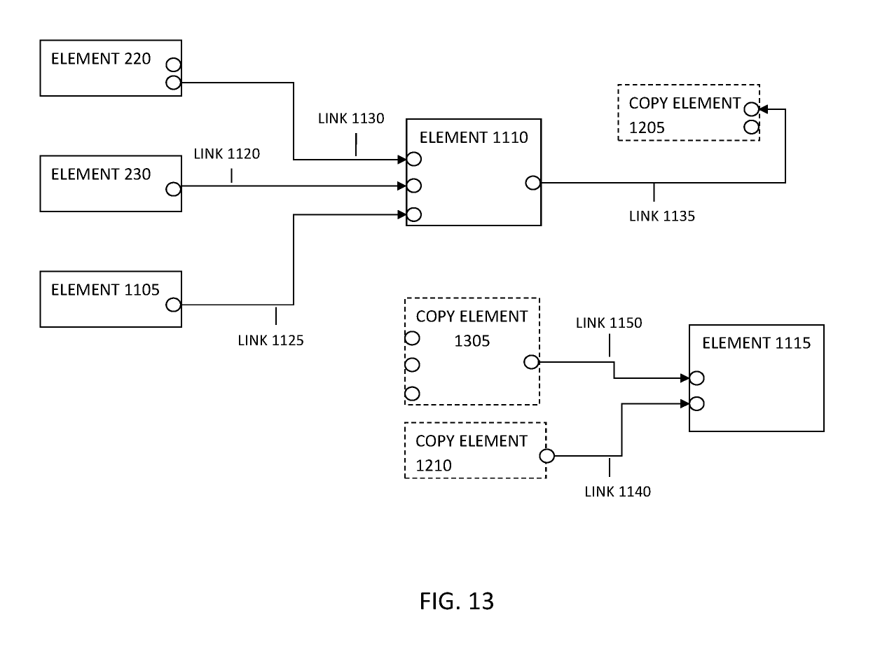

FIG. 13 is an example of dividing program 1100 of FIG. 12. Element 1305 is a copy of element 1110. Program 1100 of FIG. 12 is divided into two subprograms. Accordingly, the present disclosure provides a way to divide a complex program into one or more simple subprograms.

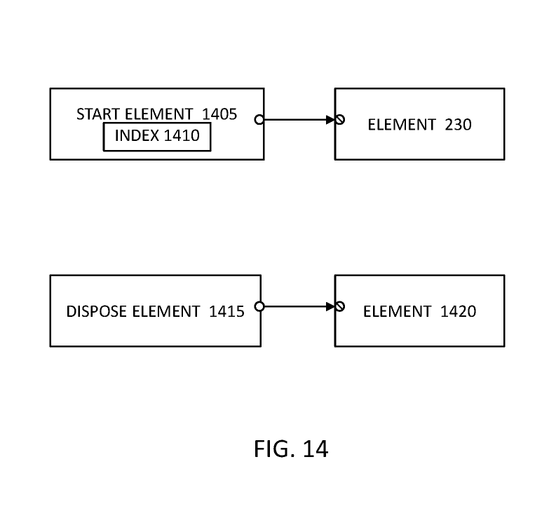

FIG. 14 describes a start element and a dispose element.

Start element 1405 is a special element and can initiate element 230. Start element 1405 has an index 1410. Index 1410 has a value that can be a number or a string. During execution of element 1405, program module 120 triggers start element 1405 based on the value of index 1410. For example, when index 1410 has a number “1” and program module 120 will trigger start element 1405. Start element 1405 will send a set of initial values to element 1420 for initiation. When index 1410 has a number “0”, program module 120 will not trigger start element 1405. Start element 1405 will not send a set of initial values to element 230.

When start element 1405 is triggered, parameter 1 and parameter 2 of element 230, as shown in FIG. 8, will be initialized. When start element 1405 is not triggered, parameter 1 and parameter 2 of element 230 will not be initialized.

Dispose element 1415 is a special element. When an element 1420 is not needed, element 1420 will search dispose element 1415. Dispose element 1415 will then trigger element 1420. Element 1420 can release all allocated resources.

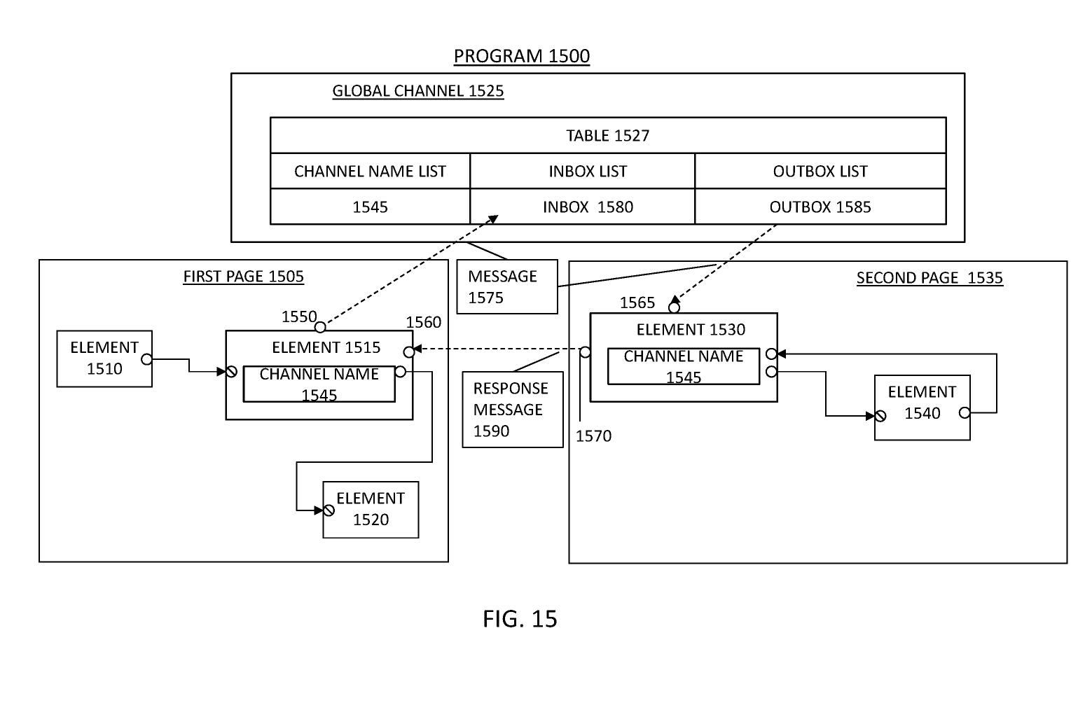

FIG. 15 is a diagram of a first page of a program to communicate with a second page of the program through a global channel.

When a program has more than one page, communications among different pages can be achieved through a global channel.

Program 1500 has a first page 1505 and a second page 1535. First page 1505 includes an element 1510, an element 1515 and an element 1520. Second page 1535 includes an element 1530 and an element 1540. Because element 1510 and element 1540 are not on a same page, direct communication with connectors between element 1510 and element 1540 cannot be achieved.

Program 1500 further includes a global channel 1525. Global channel 1525 can establish a communication between element 1510 on first page 1505 and element 1540 on second page 1535.

Global channel 1525 is a storage that stores a plurality of channel names and has a plurality of inboxes and a plurality of outboxes. Global channel 1525 further includes a table 1527 having three columns. A first column has a channel name list, a second column has an inbox list, and a third column has an outbox list.

Channel name list has a list of channel names of incoming virtual connectors and outgoing virtual connectors. Inbox list has the plurality of inboxes that store incoming messages from incoming virtual connectors. Outbox list has the plurality of outboxes that stores incoming messages for outgoing virtual connectors. Outgoing virtual connectors subscribe incoming messages of incoming virtual connectors.

Any element can access global channel 1525, and searches its channel name that is stored in global channel 1525.

Element 1515 is a special element. Element 1515 receives input data from element 1510 and sends output data to element 1520. Element 1515 includes a channel name 1545 and two virtual connectors 1550 and 1560.

Virtual connectors 1550 and 1560 are special connectors. Different from any connector discussed above such as connector 545, connectors 1550 and 1560 are not connected with anything with a solid logical link. Instead, a dash link is utilized to represent that there is a data transmission through the dash link. After the data transmission is complete, virtual connectors can release any memory resource when element 1515 is not triggered.

Element 1515 is triggered by element 1510. After element 1515 is triggered by element 1510, element 1515 searches channel name 1545 in global channel 1525. If element 1515 cannot find channel name 1545 in the channel name list of global channel 1525, global channel 1525 can create channel name 1545 and further create corresponding inbox 1580 and outbox 1585 for element 1515.

After element 1515 finds channel name 1545 or channel name 1545 is created in global channel 1525, element 1515 will send a message 1575 through virtual connector 1550. Virtual connector 1550 is an incoming virtual connector for global channel 1525.

Message 1575 includes message information from element 1510 to element 1540. Message 1575 further includes information of virtual connector 1560 so that element 1530 knows that a response message 1590 will be delivered to virtual connector 1560. Information of virtual connector 1560 includes a return address for response message 1590. Message 1575 is stored in inbox 1580, and then sent to an outbox 1585 for element 1530.

Element 1530 is also a special element. Element 1565 has two virtual connectors 1565 and 1570 and has a same channel name 1545 as element 1515. Element 1530 subscribes message 1575 in accordance with channel name 1545.

Element 1530 can access global channel 1525 at any time. For example, element 1530 can access global channel 1525 before element 1515 accesses global channel 1525. When element 1530 accesses global channel 1525 before element 1515 accesses global channel 1525, element 1530 searches channel name 1545 in global channel 1525. If element 1530 cannot find channel name 1545 in global channel 1525, global channel 1525 can create channel name 1545 and further create corresponding inbox 1580 and outbox 1585 for element 1530.

Message 1575 is stored in inbox 1580 and is delivered to outbox 1585 by global channel 1525. Once outbox 1585 has message 1575, global channel 1525 sends a trigger to element 1530 so that element 1530 can receive message 1575 through virtual connector 1565. Virtual connector 1565 is an outgoing virtual connector for global channel 1525.

After element 1530 receives message 1575, element 1530 sends message 1575 to element 1540. Element 1540 can process message 1575 and sends output data to element 1530. Element 1530 then sends response message 1590 to element 1550 through virtual connectors 1570 and 1560.

After element 1515 receives response message 1590, element 1515 sends output data to element 1520.

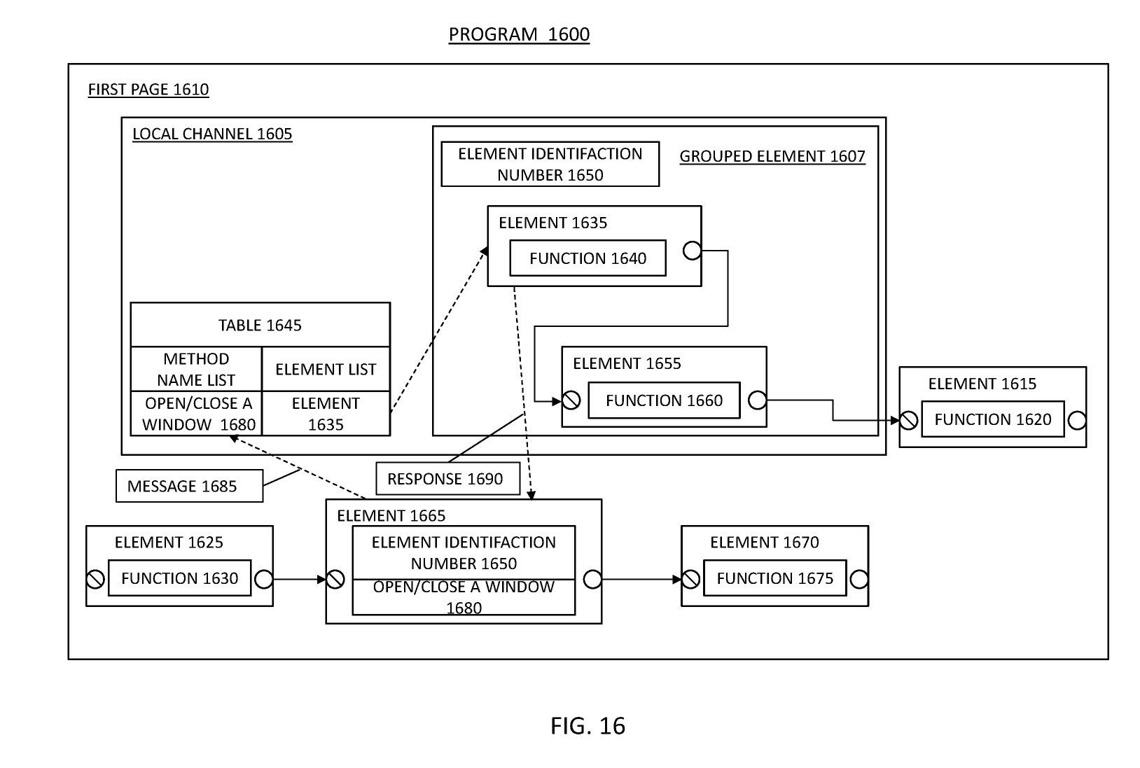

In an object oriented programming languages, an object can utilize a property or a method of the object to have a communication with outside world. A direct logical connection with connectors is an example of utilizing property to have a communication with outside world. A method is a procedure associated with the object. For example, a window object can have methods such as “open and close the window”, while its state (whether it is opened or closed) is a property. FIG. 16 describes a way of communication by a method.

FIG. 16 describes an example of a grouped element and an example of communicating with an element inside the grouped element through a local channel.

Communications among elements in a single page can be achieved by direction communication through links or via a local channel.

Program 1600 includes a first page 1610. First page 1610 includes a local channel 1605, an element 1625, an element 1665 and an element 1670.

Local channel 1605 includes a grouped element 1607 and a table 1645.

Grouped element 1607 includes an element identification number 1650, an element 1635, and an element 1655. Identification number 1650 can help to locate element 1607. Grouped element 1607 is generated by copying and pasting element 1635 and element 1655 on first page 1610 of program 1600. FIG. 16 describes a method of having a communication between element 1665 and element 1635 that is located inside grouped element 1607.

Table 1645 has two columns. A first column has a method name list and a second column has a corresponding element list. For example, table 1645 identifies a method name open/close a window 1680 corresponds to element 1635, because function 1640 of element 1635 can open and close a window. Table 1645 lists all the method names and element numbers corresponding to method name s that are included in grouped element 1607.

Element 1625 provides output data to element 1665. Element 1625 triggers element 1665.

Element 1665 is a special element. Element 1665 includes element identification number 1650 and a method name 1680. Element 1665 can communicate with any element having method name 1680 in grouped element 1607. When an element tries to communicate with an element in a grouped element, the element has to have the same element identification number as that of the grouped element. Here element 1665 has element identification number 1650, which is the same as element identification number 1650 of grouped element 1607.

Element 1625 sends output data to element 1665 to trigger element 1665. Element 1665 establishes a communication with local channel 1605 because element 1665 and grouped element 1605 have the same element identification number 1650. Element 1665 starts to search method name 1680 in table 1645. If local channel 1605 can find an element number corresponding to method name 1680 in table 1645, the communication between element 1665 and local channel 1605 continues. If local channel 1605 cannot find an element number corresponding to method name 1680, the communication between element 1665 and local channel 1605 stops unless local channel 1605 creates a method name 1680 and identifies an element corresponding to method name 1680 in grouped element 1607.

Element 1665 sends a message 1680 to local channel 1605. Local channel 1605 sends message 1685 to element 1635 to execute function 1640. After execution, element 1635 sends a response message 1690 to element 1665 to perform a method open/close a window. After element 1665 receives message 1690, element 1665 sends output data to element 1670.

Because grouped element 1607 and element 1665 are on the same first page 1610, no connector or virtual connector is necessary. Communications between grouped element 1607 and element 1665 can be performed by elements directly.

In summary, FIG. 15 describes a method of having global communications among elements on different pages of a program. FIG. 16 describes a method of having local communications among elements on a same page.

FIG. 17 is an example of generating a program.

A computer program usually has a set of input data and generates another set of output data. As a part of a subprogram, an element usually has a certain type of input data and generates another certain types of output data.

The below describes a procedure of creating a target program that has input data A and B, and has output data X and Y. The procedure is also an illustration to describe how search engine 155 searches a plurality of elements to generate a new program.

User 101 or program module 120 can generate an element that can be stored in library 150. When program module 120 generates an element, program module 120 reads program codes of a function and wraps the function in a format of an element with input data and output data identified. All generated element can then stored in library 150.

In FIG. 17, program module 120 generates an element 1706, an element 1716, an element 1732, an element 1742 and an element 1746. Element 1706, element 1716, element 1732, element 1742 and element 1746 are stored in library 150.

Element 1706 includes a function 1708 and a connector 1750. Function 1708 is triggered by an input data A and generates an output data C. A link 1702 stores a triggering sequence “1”. Output data C is sent to element 1742 and element 1732. A link 1724 stores a triggering sequence “1.1”. A link 1722 stores a triggering sequence “1.2”. Accordingly, output data C triggers element 1742 first and is sent to element 1732 secondly. Connector 1750 determines the triggering sequence “1.1” and “1.2”.

Element 1716 includes a function 1718. Function 1718 is triggered by an input data B and generates an output data D. Link 1702 stores a triggering sequence “2”. A link 1726 stores a triggering sequence “2”.

Element 1732 includes a function 1734. Function 1734 is triggered by an input data D and includes an input data C. Function 1735 generates an output data F. Element 1732 receives input data C first and receives input data D secondly based on the triggering sequence numbers.

Element 1742 includes a function 1744. Function 1744 is triggered by an input data C. Function 1744 generates output data X.

Element 1746 includes a function 1748. Function 1748 is triggered by an input data F. Function 1745 generates an output data “Y”.

Program 1760 has input data A and B and has output data X and Y. Accordingly, program 1760 meets the requirements of target program 1700. Program 1705 is an example of target program 1700.

The below descries the procedures of generating program 1760.

Step 1: search a first set of elements that have A, B, or A and B as input data, and list output data of the first set of elements;

Step 2: search a second set of elements that have X and Y as output data, and list input data of the second set of element;

Step 3: search a third set of intermediate elements that have direct or indirect connections with the first set of elements and the second set of elements;

Step 3a: search elements that have output data of the first set of elements, and output data of the first set of elements will be input data for the searched element in step 3a;

Step 3b: search elements that have input data of the second set of element, and input data of the second set of elements will be output data for the searched elements in step 3b;

Step 3c: repeat step 3a and 3b until the connections of step 3 are established.

Step 4: logically connect the first, second, and third set of elements to generate the target program.

In FIG. 17, elements 1706 and 1716 are the first set of elements. Elements 1742 and 1746 are the second set of elements. Element 1732 is the third set of element.

The present disclosure can be widely utilized in many applications such as pattern search, stock market, traffic control, artificial intelligence and machining learning.

The present disclosure can find a predictive pattern from a large amount of information. For example, the present application can be applied to solve traveling salesman problem: given a list of cities and the distances between them, what is the shortest possible route that traverses each city exactly once, returning to the original city? According to the present disclosure, a function can now be considered as a city in the traveling salesman problem. A plurality of elements can be generated between two different cities. After the plurality of elements is generated, program module 120 connects different elements to have many different paths. Each path can be a program. Since the number of all possible paths is very large, the search to find a shortest path can be done on a subset of all possible paths. A different path represents a solution to a subset of travelling salesman problems. Program module 120 can improve the solution by using, for example, machine time to identify the solution to make a final complete path shorter and shorter. A final solution based on the solutions to the subset of travelling salesman problems will be sufficiently close to an optimum solution.

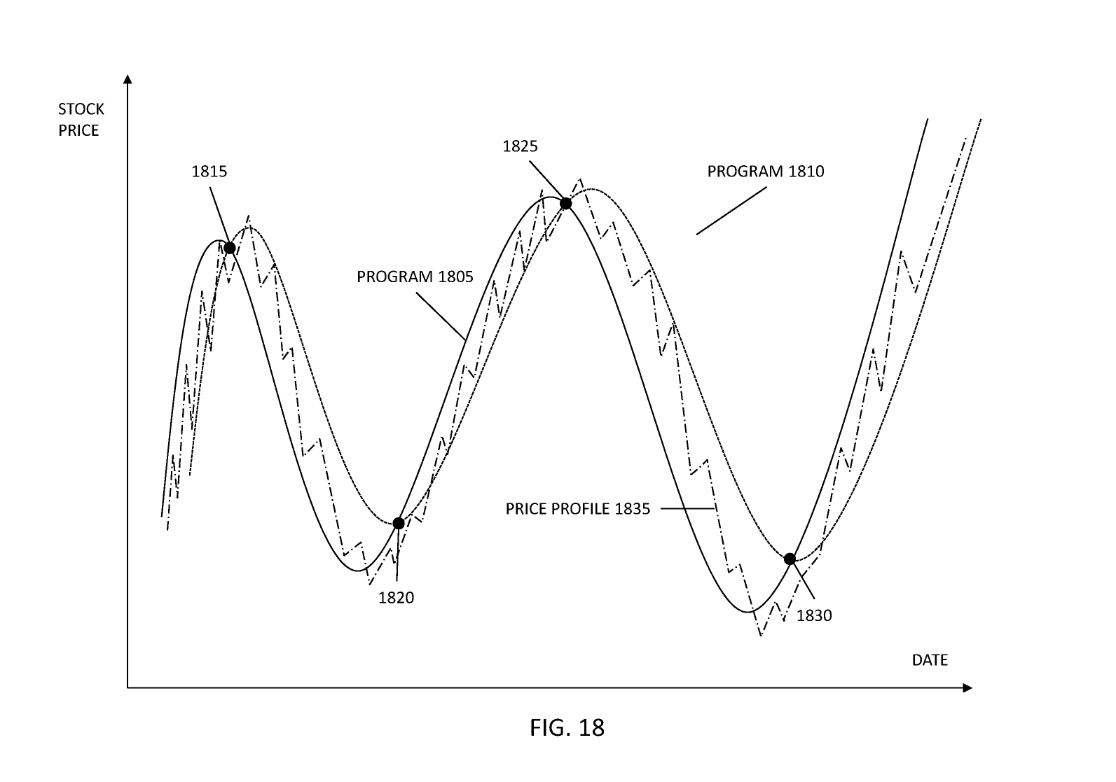

Further, the present disclosure can be applied in a stock market. FIG. 18 is an exemplary application of the present disclosure in the stock market. Program 1805 and program 1810 can be generated to simulate price change with time for a same stock. Program 1805 can comprise one or more known indicator functions, and program 1810 can comprise one or more known indicator functions that are different from these of program 1805. Every indicator function was developed by financial professionals and can theoretically estimate stock price changing with time. There are normally over 200 financial indicator functions available for every stock. Open source codes for indicator functions written in a high-level language such as Python or Java can also be accessible. The present application can read program codes of indicator functions, organize input data and output data of these indicator functions, and wrap the indicator functions into different elements automatically. Every element includes an indicator function and is stored in library 150.

From output data of program 1805 and 1810, a plurality of cross points 1815, 1820, 1825 and 1830 can be determined from program 1805 and program 1810. Cross points 1815, 1820, 1825 and 1830 are either buying or selling points. When cross points 1815, 1820, 1825 and 1830 are determined, a comparison can be made between cross points 1815, 1820, 1825, and 1830 and real buying or selling points for a price profile 1835 of the stock. Price profile 1835 is the real price profile of the stock in the past. After the comparison, an accuracy of cross points 1815, 1820, 1825 and 1830 can be evaluated from a level of deviation from the real buying or selling points. When the accuracy is low, programs 1805 or 1810 can be modified with different indicator functions. When the accuracy is high, program 1805 and 1810 can be applied to predicate the buying or selling points of the stock in the future.

The present disclosure can be applied to artificial intelligence and machine learning. Traditionally, a programmer has to have an exact algorithm to find an optimal solution in the process of code development, which makes the optimization process difficult, because the programmer has to find out one of the best methods first, generate codes and provide the codes to a computer. In the present disclosure, program module 120 can learn, on its own, how to modify a program, and improve a solution continuously. A modified program will be stored in library 150.

This present disclosure presents a new method of wrapping program codes. The new wrapping object is an element. An element communicates to other elements via connectors and links. When input data is updated, it can trigger function of the element. Output data of the element will trigger other elements subsequently. This cascading effect allows the element to be updated as soon as input date is updated. This cascading effect continues until the data reaches the end of a program. Accordingly, in the present disclosure, operation of the program depends on data flow instead of logical sequence. More specifically, the program depends on functionality and data connections instead of command code sequences. The present disclosure presents a data-driven programming.

The techniques described herein are exemplary, and should not be construed as implying any particular limitation on the present disclosure. It should be understood that various alternatives, combinations and modifications could be devised by those skilled in the art. For example, steps associated with the processes described herein can be performed in different order, unless otherwise specified or dictated by the steps themselves. The present disclosure is intended to embrace all such alternatives, modifications and variances that fall within the scope of the appended claims.

The terms “comprises” or “comprising” are to be interpreted as specifying the presence of the stated features, integers, steps or components, but not precluding the presence of one or more other features, integers, steps or components or groups thereof. The terms “a” and “an” are indefinite articles, and as such, do not preclude embodiments having pluralities of articles.

While the present disclosure has been described with reference to one or more exemplary embodiments, it will be understood by those skilled in the art that various changes can be made and equivalents can be substituted for elements thereof without departing from the scope of the present disclosure. In addition, many modifications can be made to adapt a particular situation or material to the teachings of the disclosure without departing from the scope thereof. Therefore, it is intended that the present disclosure not be limited to the particular embodiment(s) disclosed as the best mode contemplated, but that the disclosure will include all embodiments falling within the scope of the appended claims.

What is claimed is:

1. A method, executed by a processor, comprising,
generating a program from a first subprogram and a second subprogram;
executing said program to yield an interim result;
comparing said interim result to a reference result;
determining that said interim result is an improvement over said reference result;
modifying said program; and
repeating said executing, said comparing, said determining, and said modifying to yield a result for said program that is an improvement over a target result.

2. The method of claim 1, wherein said generating comprises:
obtaining said first subprogram and said second program from a library; and
linking said first subprogram with said second subprogram.

3. The method of claim 1,
wherein said program is in a form of machine code, and
wherein said modifying is achieved by modifying said machine code.

4. The method of claim 1, further comprising:
generating a graphical representation of said program, and,
transmitting said graphical representation to a display.

5. The method of claim 4,
wherein said modifying comprises,
receiving a communication to modify said graphical representation, thus yielding a modification of said graphical representation; and
modifying said program in accordance with said modification of said graphical representation.

6. The method according to claim 1, furthering comprising,
utilizing a first element corresponding to said first subprogram; and
utilizing a second element corresponding to said second subprogram,
wherein each of said first element and said second element comprises a first non-triggering connector for data input, and a second non-triggering connector for data output,
wherein said second non-triggering connector of said first element is connected through a logical link with said first non-triggering connector of said second element to create said graphical representation on said display, and
wherein said second subprogram is triggered by a triggering connector.

7. A system comprising:
a processor; and
a storage device that contains instructions that are readable by said processor to cause said processor to:
generate a program from a first subprogram and a second subprogram;
execute said program to yield an interim result;
compare said interim result to a reference result;
determine that said interim result is an improvement over said reference result;
modify said program; and
repeat said execute, said compare, said determine, and said modify to yield a final target result for said program that is an improvement over a target result.

8. The system of claim 7,
wherein to generate said program, said instructions cause said processor to:
obtain said first subprogram and said second program from a library; and
link said first subprogram with said second subprogram.

9. The system of claim 7,
wherein said program is in a form of machine code, and
wherein to modify said program, said instructions cause said processor to:
modify said machine code.

10. The system of claim 7, comprising further instructions that cause said processor to:
generate a graphical representation of said program; and
transmit said graphical representation to a display.

11. The system of claim 10,
wherein to modify said program, said instructions cause said processor to:
receive a communication to modify said graphical representation of said program, thus yielding a modification of said graphical representation; and
modify said program in accordance with said modification of said graphical representation.

12. The system of claim 7, comprising further instructions that cause said processor to:
utilize a first element corresponding to said first subprogram; and
utilize a second element corresponding to said second subprogram,
wherein each of said first element and said second element comprises a first non-triggering connector for data input, and a second non-triggering connector for data output,
wherein said second non-triggering connector of said first element is connected through a logical link with said first non-triggering connector of said second element to create said graphical representation on said display, and
wherein said second subprogram is triggered by a triggering connector.

13. A storage device that is non-transitory and contains instructions that are readable by a processor to cause said processor to:
generate a program from a first subprogram and a second subprogram;
execute said program to yield an interim result;
compare said interim result to a reference result;
determine that said interim result is an improvement over said reference result and over a target result;
replace said reference result with said interim result;
modify said program; and
repeat said execute, said compare, said determine, said replace, and said modify to yield a result for said program that is an improvement over said result.

14. The storage device of claim 13,
wherein to generate said program, said instructions cause said processor to:
obtain said first subprogram and said second program from a library; and
link said first subprogram with said second subprogram.

15. The storage device of claim 13,
wherein said program is in a form of machine code, and
wherein to modify said program, said instructions cause said processor to:
modify said machine code.

16. The storage device of claim 13, comprising further instructions that cause said processor to:
generate a graphical representation of said program; and
transmit said graphical representation to a display.

17. The storage device of claim 16,
wherein to modify said program, said instructions cause said processor to:
receive a communication to modify said graphical representation of said program, thus yielding a modification of said graphical representation; and
modify said program in accordance with said modification of said graphical representation.

18. The storage device of claim 13, comprising further instructions that cause said processor to:
utilize a first element corresponding to said first subprogram; and
utilize a second element corresponding to said second subprogram,
wherein each of said first element and said second element comprises a first non-triggering connector for data input, and a second non-triggering connector for data output,
wherein said second non-triggering connector of said first element is connected through a logical link with said first non-triggering connector of said second element to create said graphical representation on said display, and
wherein said second subprogram is triggered by a triggering connector.
